(19) United States
(12) Patent Application Publication
(10) Pub. No.: US 2021/0227643 A1
(43) Pub. Date: Jul. 22, 2021

(54) INDUCTION HEATING APPARATUS AND METHOD OF CONTROLLING THE SAME

(71) Applicant: Samsung Electronics Co., Ltd., Suwon-si (KR)

(72) Inventors: Taro YOSHIDA, Yokohama-shi (JP); Masaki ONO, Yokohama-shi (JP); Masashi SASAGAWA, Yokohama-shi (JP); Masayuki OTAWARA, Yokohama-shi (JP); Nobuharu NISHIKOORI, Yokohama-shi (JP); Tomoyuki KANAGAWA, Yokohama-shi (JP); Yutaka YAGI, Yokohama-shi (JP)

(21) Appl. No.: 17/149,042

(22) Filed: Jan. 14, 2021

(30) Foreign Application Priority Data
Jan. 16, 2020 (JP) 2020-004918
Jul. 6, 2020 (KR) 10-2020-0083091

(51) Int. Cl. H05B 6/06; H02M 7/5387; H05B 6/12

(52) U.S. Cl. CPC H05B 6/062; H05B 6/1209; H02M 7/53871

(57) ABSTRACT

An induction heating device using a resonance circuit method and a control method thereof that are capable of preventing occurrence of overcurrent even when an object is moved are provided. The induction heating device for heating an object includes a resonance circuit including a heating coil and a condenser, an inverter configured to supply power to the resonance circuit, a detector configure to detect a value related to a movement of the object, and at least one processor configured to identify whether the object is moved based on the value detected by the detector, and upon determining that the object is moved, lower a driving frequency of the inverter and an output of the inverter.

### CROSS-REFERENCE TO RELATED APPLICATION(S)

This application is based on and claims priority under 35 U.S.C. § 119(a) of a Korean patent application number 10-2020-0083091, filed on Jul. 6, 2020, in the Korean Intellectual Property Office, and of a Japanese patent application number 2020-004918, filed on Jan. 16, 2020, in the Japanese Patent Office, the disclosure of each of which is incorporated by reference herein its entirety.

### BACKGROUND

### 1. Field

The disclosure relates to an induction heating apparatus including a resonance circuit having a heating coil, and a method of controlling the same.

### 2. Description of the Related Art

In general, an induction heating device having a resonance circuit may adopt a technique of constantly controlling the output power of an inverter by adjusting the switching frequency of the inverter according to the fluctuation of the resonance frequency.

However, when an object, such as a pot, placed on an induction heating device, is lifted or separated by shaking or the like, the resonance frequency of the circuit is caused to be dynamically changed so that the energy accumulated in a heating coil may be released at a time, which may lead to overcurrent.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an induction heating device using a resonance circuit method that is capable of preventing overcurrent even when an object is moved, and a method of controlling the same.

Additional aspects will be set forth in part in the description which follows and, in part, will be apparent from the description, or may be learned by practice of the presented embodiments.

In accordance with an aspect of the disclosure, an induction heating device for heating an object is provided. The apparatus includes a resonance circuit including a heating coil and a condenser, an inverter configured to supply power to the resonance circuit, a detector configure to detect a value related to a movement of the object, and at least one processor configured to identify whether the object is moved based on the value detected by the detector, and upon determining that the object is moved, lower a driving frequency of the inverter and an output of the inverter.

The at least one processor may be further configured to lower the driving frequency of the inverter and the output of the inverter to maintain an impedance of the resonance circuit while lowering a heating capacity of the induction heating device.

Upon determining that the object is moved, the at least one processor may be further configured to compare the driving frequency of the inverter with a frequency setting value, and in response to the driving frequency of the inverter being larger than the frequency setting value, lower the driving frequency of the inverter by a preset frequency.

The at least one processor may be further configured to lower the driving frequency of the inverter by the preset frequency until the driving frequency of the inverter becomes lower than or equal to the frequency setting value.

Upon determining that object is moved, the least one processor may compare the output of the inverter with an output setting value, and in response to the output of the inverter being larger than the output setting value, lower the output of the inverter by a preset output.

The at least one processor may be further configured to lower the output of the inverter by the preset output until the output of the inverter becomes lower than or equal to the output setting value.

The resonance circuit may include a compound resonance circuit including a series resonance circuit and a parallel resonance circuit, and the at least one processor may be further configured to control the driving frequency of the inverter for the parallel resonance circuit to operate near a resonance frequency.

The resonance circuit may be switchable between a series resonance circuit and a complex resonance circuit by on and off operations of a switch, and the at least one processor may be further configured to control the switch for the resonance circuit to operate as the series resonance circuit or as the compound resonance circuit.

The detector may include at least one ammeter configured to detect a current flowing through the heating coil, and the at least one processor may be further configured to identify that the object is moved in response to a value of the current detected by the ammeter exceeding a reference current value.

The detector may include an ammeter configured to detect a current flowing through the heating coil, and the at least one processor may be further configured to identify whether the object is moved based on the output of the inverter and a value of the current detected by the ammeter.

In accordance with another aspect of the disclosure, a method of controlling an induction heating apparatus is provided. The method includes a resonance circuit including a heating coil and a condenser for heating an object and an inverter for supplying power to the resonance circuit, the method including detecting, by a detector, a value related to a movement of the object, determining whether the object is moved based on the value detected by the detector, and upon determining that the object is moved, lowering a driving frequency of the inverter and an output of the inverter.

The lowering of the driving frequency of the inverter and the output of the inverter may include lowering the driving frequency of the inverter and the output of the inverter to maintain an impedance of the resonance circuit while lowering a heating capacity of the induction heating device.

The lowering of the driving frequency of the inverter and the output of the inverter may include upon determining that the object is moved, comparing the driving frequency of the inverter with a frequency setting value, and in response to the driving frequency of the inverter being larger than the frequency setting value, lowering the driving frequency of the inverter by a preset frequency.

The lowering of the driving frequency of the inverter and the output of the inverter may include lowering the driving frequency of the inverter by the preset frequency until the driving frequency of the inverter becomes lower than or equal to the frequency setting value.

The lowering of the driving frequency of the inverter and the output of the inverter may include upon determining that object is moved, comparing the output of the inverter with an output setting value, and in response to the output of the inverter being larger than the output setting value, lowering the output of the inverter by a preset output.

The lowering of the driving frequency of the inverter and the output of the inverter may include lowering the output of the inverter by the preset output until the output of the inverter becomes lower than or equal to the output setting value.

The resonance circuit may include a compound resonance circuit including a series resonance circuit and a parallel resonance circuit, and the method may further include controlling the driving frequency of the inverter for the parallel resonance circuit to operate near a resonance frequency.

The resonance circuit may be switchable between a series resonance circuit and a complex resonance circuit by on and off operations of a switch, and the method may further include controlling the switch for the resonance circuit to operate as the series resonance circuit or as the compound resonance circuit.

The detector may further include at least one ammeter configured to detect a current flowing through the heating coil, and the determining of whether the object is moved may include determining that the object is moved in response to a value of the current detected by the ammeter exceeding a reference current value.

The detector may further include an ammeter configured to detect a current flowing through the heating coil, and the determining of whether the object is moved may include determining whether the object is moved based on the output of the inverter and a value of the current detected by the ammeter.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings of which:

FIG. 1 is a diagram illustrating an example of a configuration of an induction heating device according to an embodiment of the disclosure;

FIG. 2 is a flowchart illustrating an example of a method of controlling the induction heating device according to an embodiment of the disclosure;

FIG. 3 is a diagram illustrating an example of a waveform and a phase of each current in the induction heating apparatus according to an embodiment of the disclosure;

FIG. 4 is a diagram illustrating a phase vector of each current in the induction heating apparatus according to an embodiment of the disclosure;

FIG. 5 is a diagram illustrating a frequency characteristic of an impedance in the induction heating apparatus according to an embodiment of the disclosure;

FIG. 6 is a diagram illustrating an example of a change in driving frequency and output in response to detection of a pot floatation according to an embodiment of the of disclosure;

FIG. 7 is a flowchart illustrating another example of the method of controlling the induction heating device according to an embodiment of the disclosure;

FIG. 8 is a diagram illustrating another example of the configuration of the induction heating device according to an embodiment of the disclosure;

FIG. 9 is a diagram illustrating another example of the configuration of the induction heating device according to an embodiment of the disclosure;

FIG. 10 is a diagram illustrating another example of the configuration of the induction heating device according to an embodiment of the disclosure;

FIG. 11 is a diagram illustrating another example of the configuration of the induction heating device according to an embodiment of the disclosure;

FIG. 12 is a diagram illustrating another example of the configuration of the induction heating device according to an embodiment of the disclosure; and

FIG. 13 is a diagram illustrating a frequency characteristic of the impedance in the induction heating apparatus shown in FIG. 12 according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Like numerals refer to like elements throughout the specification. Not all elements of embodiments of the disclosure will be described, and description of what are commonly known in the art or what overlap each other in the embodiments will be omitted. The terms as used throughout the specification, such as “˜ part”, “˜ module”, “˜ member”, “˜ block”, etc., may be implemented in software and/or hardware, and a plurality of “˜ parts”, “˜ modules”, “˜ members”, or “˜ blocks” may be implemented in a single element, or a single “˜ part”, “˜ module”, “˜ member”, or “˜ block” may include a plurality of elements.

It will be further understood that the term “connect” or its derivatives refer both to direct and indirect connection, and the indirect connection includes a connection over a wireless communication network.

It will be further understood that the terms “comprises” and/or “comprising,” when used in this specification, specify the presence of stated features, integers, operations, elements, and/or components, but do not preclude the presence or addition of one or more other features, integers, operations, elements,

Further, it will be further understood when a signal or data is transferred, sent or transmitted from “an element” to “another element”, it does not exclude another element between the element and the other element passed by the signal or data therethrough, unless the context clearly indicates otherwise

As used herein, the singular forms “a,” “an” and “the” are intended to include the plural forms as well, unless the context clearly indicates otherwise.

Although the terms “first,” “second,” “A,” “B,” etc. may be used to describe components or pieces of data, the terms do not limit the position, the priority, the processing order, or the data value size of the corresponding components or pieces of data, but are used only for the purpose of distinguishing one component from another component or one piece of data from another piece of data.

Reference numerals used for method operations are just used for convenience of explanation, but not to limit an order of the operations. Thus, unless the context clearly dictates otherwise, the written order may be practiced otherwise.

Hereinafter, embodiments of an induction heating apparatus and a method of controlling the same according to aspects will be described in detail with reference to the accompanying drawings.

Hereinafter, embodiments of the disclosure will be described with reference to the drawings. Here, the description of the following embodiments should be regarded as illustrative rather than limiting the disclosure, and the application or use thereof.

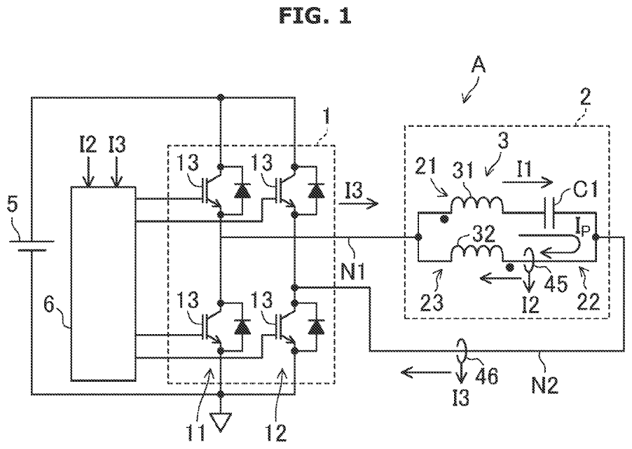

FIG. 1 is a diagram illustrating an example of a configuration of an induction heating device according to an embodiment the disclosure.

Referring to FIG. 1, an induction heating device A includes an inverter 1 that converts direct current (DC) power received from a DC power source 5 into alternating current (AC) power and outputs the AC power, a resonance circuit 2 including a heating coil 3 that generates heat by receiving power from the inverter 1, ammeters 45 and 46, and a controller 6.

The circuit configuration of the inverter 1 is not limited thereto, and may adopt configurations of the related art. For example, FIG. 1 illustrates an example of the inverter 1 with a bridge configuration in which two pairs of arms 11 and 12 are connected in parallel. In FIG. 1, two switching elements 13 are connected in series in each pair of arms 11 and 12.

In addition, each switching element 13 has a parallel circuit including a transistor and a diode connected to the transistor in parallel and in a reverse direction. Further, in the inverter 1, each switching element 13 is switched under the control of the controller 6 so that DC power is converted into AC power and the AC power is output.

In the following description, a connection node between the two switching elements 13 of one arm 11 is referred to as a first node N1, and a connection node between the two switching elements 13 of the other arm 12 is referred to as a second node N2.

The resonance circuit 2 may be a compound resonance circuit including a series resonance circuit and a parallel resonance circuit. The resonance circuit 2 has a heating coil 3 and a condenser C1 provided between the first node N1 and the second node N2.

The heating coil 3 may include a first heating coil 31 and a second heating coil 32. Specifically, the first heating coil 31 and the condenser C1 are connected in series between the first node N1 and the second node N2 to form a series resonance circuit 21.

In addition, the second heating coil 32 is connected in parallel to the series resonance circuit 21 to form a parallel resonance circuit 22. That is, the parallel resonance circuit 22 includes the first and second heating coils 31 and 32 and the condenser C1. In other words, a closed loop circuit 23 may be formed by the first heating coil 31, the condenser C1, and the second heating coil 32.

Here, a specific configuration of the heating coil 3 is not particularly limited. For example, the first heating coil 31 and the second heating coil 32 may be formed as physically separate coils, or may be formed as a heating coil 3 that is physically unitary but is electrically divided.

In FIG. 1, the direction of a current is indicated by an arrow. With a configuration shown in FIG. 1, a loop current Ip flows through the closed loop circuit 23. In the following description, a current flowing through the first heating coil 31 is referred to as a first current I1, and a current flowing through the second heating coil 32 is referred to as a second current I2.

In addition, a current flowing through the first node N1 and the second node N2 is referred to as a third current I3. The ammeter 45 is provided to measure the second current I2, and the ammeter 46 is provided to measure the third current I3. The ammeters 45 and 46 are an example of a detector that detects a value related to the movement of an object.

The controller 6 includes hardware, such as a central processing unit (CPU) and a memory, and software, such as a control program, and may control the overall operation of the induction heating device A. For example, the controller 6 may include at least one memory in which a program for performing operations described below is stored and at least one processor for executing the stored program.

The controller 6 may control the switching operation of the switching element 13 to control the frequency F of the current flowing through the heating coil 3 (the first heating coil 31 and the second heating coil 32). Specifically, the controller 6 may set the heating amount according to manipulation information of a manipulator (not shown), or may adjust the heating amount according to the state of the object, or stop heating.

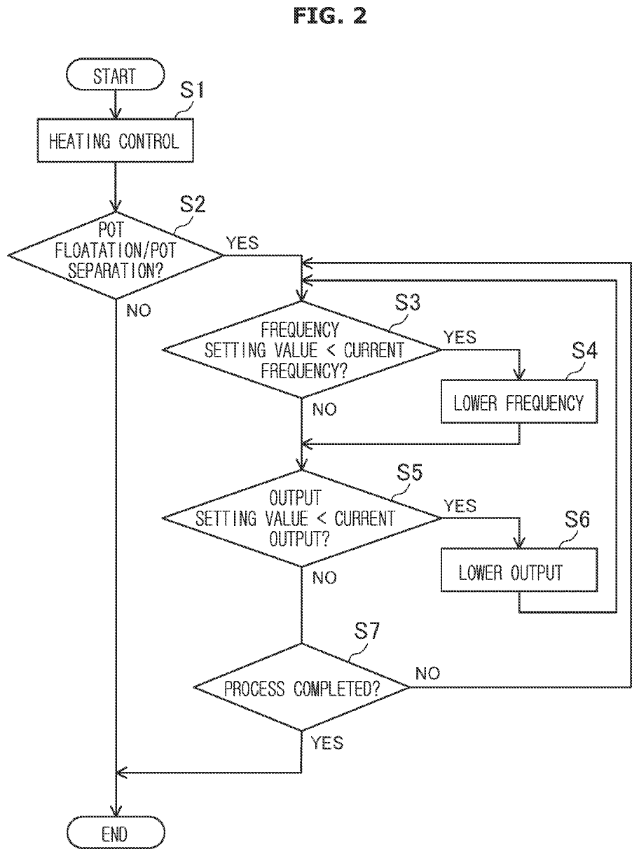

Hereinafter, an operation of the controller 6 based on detection of movement of a pot, such as floatation or separation of a pot, will be described in detail with reference to FIG. 2. Here, an example in which a pot is heated as an object in the induction heating device will be described. In addition, the controller 6 is an agent of the control in the description of FIG. 2 shown below, but the description of identifying the agent may be omitted.

FIG. 2 is a flowchart illustrating an example of a method of controlling the induction heating device according to an embodiment of the disclosure.

Referring to FIG. 2, in operation S1, the controller 6 starts heating control in a normal operation state. Specifically, in a normal operation state, the controller 6 controls the switching element 13 such that an absolute value |Z1| of an impedance Z1 of the series resonance circuit 21 is equal to an absolute value |Z2| of an impedance Z2 of the second heating coil 32. For the sake of convenience in description, the control of the controller 6 in such a normal operation state will be referred to as “normal operation control”.

Equation 1 is an equation representing the impedance Z1 of the series resonance circuit 21, and Equation 2 is an equation representing the impedance Z2 of the second heating coil 32.

$$\begin{matrix}Equation 1 & \\ {Z}_{1} = \frac{j ( {ω}^{2} {L}_{1} {C}_{1} )}{ω {C}_{1}} & ( 1 ) \\ Equation 2 & \\ {Z}_{2} = \frac{j}{ω {L}_{2}} & ( 2 )\end{matrix}$$

In Equations 1 and 2, ω is the angular frequency of the current flowing through the heating coil 3, C1 is the capacitance value of the condenser C1, L1 is the inductance value of the first heating coil 31, and L2 is the inductance value of the second heating coil 32. j denotes an imaginary number.

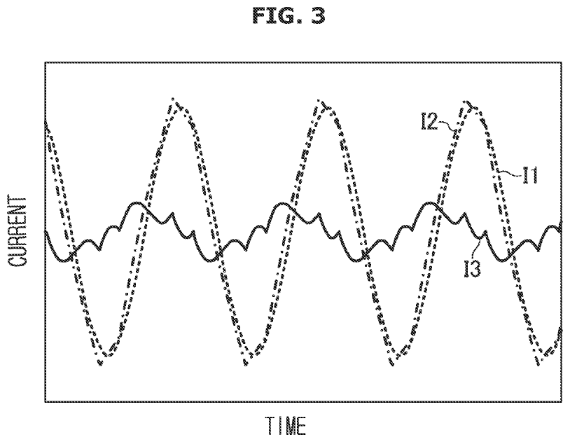

FIG. 3 is a diagram illustrating an example of a waveform and a phase of each current in the induction heating apparatus according to an embodiment of the disclosure.

Referring to FIG. 3, examples of the waveforms of the first current I1 (a dotted line), the second current I2 (a dashed-dotted line), and the third current I3 (a solid line) are illustrated when the control of the embodiment is performed. The first current I1 and the second current I2 are substantially in-phase in the direction of currents I1 and 12 in FIG. 3. As shown in FIG. 3, even when a relatively large loop current Ip is passed through the closed loop circuit 23, the third current I3, a current flowing through the inverter 1, may be provided to be small.

Using Equations 1 and 2, the frequency Fo at which the absolute value |Z1| of the impedance Z1 matches the absolute value |Z2| of the impedance Z2 is expressed as Equation 3.

$$\begin{matrix}Equation 3 & \\ Fo = \frac{1}{2 π \sqrt{{C}_{1} \times ( {L}_{1} + {L}_{2} )}} & ( 3 )\end{matrix}$$

When the inverter 1 is driven at a frequency Fo obtained in Equation 3 above, the driving frequency may be brought close to the parallel resonance frequency. In this way, the controller 6 may control the driving frequency of the inverter 1 to be near the resonance frequency of the parallel resonance circuit 22, to operate the parallel resonance circuit 22 near the resonance frequency.

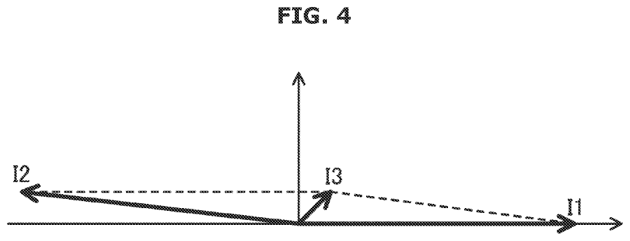

FIG. 4 is a diagram illustrating a phase vector of each current in the induction heating apparatus according to an embodiment of the disclosure. Specifically, in FIG. 4, phase vectors of respective currents I1 to I3 during a normal operation control are illustrated.

Referring to FIG. 4, the phase vector of the first current I1 and the phase vector of the second current I2 have substantially opposite directions to each other. In FIG. 4 also, it can be seen that the value of the third current I3, which is a combined current of the first current I1 and the second current I2, may be provided to be small. That is, while maintaining the current flowing through the first node N1 at a relatively small value, a relatively large current may flow through the closed loop circuit 23. That is, the induction heating device A may be operated with a high efficiency.

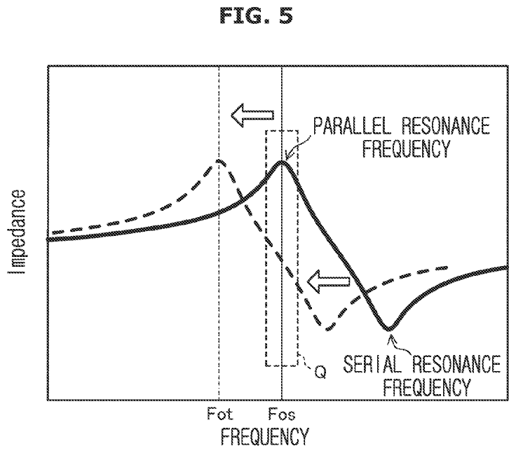

FIG. 5 is a diagram illustrating a frequency characteristic of an impedance in the induction heating apparatus according to an embodiment of the disclosure.

Referring to FIG. 5, a frequency range during normal operation control of the controller 6 is indicated by a dotted rectangular area Q. The rectangular region Q is an example showing the vicinity of the resonance frequency of the parallel resonance circuit 22, that is, the parallel resonance frequency.

In operation S2, it is identified whether a pot is moved, such as floatation or separation of a pot. For example, when an aluminum pot is used, the pot may be slightly lifted from a top plate by the electromagnetic force during heating, and “pot floatation” refers to such a condition of the pot. When the pot is floated or separated, the mutual inductance between the pot and the heating coil changes, thereby causing the impedance of the heating coil 3 to be changed.

In operation S2, a method of determining floatation/separation of a port is not particularly limited. For example, the controller 6 may identify floatation/separation of a pot based on the current measured using the ammeters 45 and 46. Specifically, when the magnitude relationship between the inverter current I3 and the current flowing through the second heating coil 32 or the first heating coil 31 is reversed, or when current that mainly flows through the inverter 1 between the inverter current I3, and the current flowing through the second heating coil 32 or the first heating coil 31 exceeds a reference current value (e.g., 30 [A]), the controller 6 may identify a pot floatation or a pot separation has occurred. Although not shown, an infrared sensor may be used to detect a pot floatation/pot separation.

When a pot floatation or pot separation occurs, the resonance frequency Fos (the serial resonance frequency and the parallel resonance frequency) of the resonance circuit 2 shifts to a low frequency side. In FIG. 5, a solid line indicates a frequency-impedance characteristic in a normal operation state, and a dotted line indicates a frequency-impedance characteristic in a pot floatation/pot separation.

The amount of a shift (Fos-Fot in FIG. 5) of the resonance frequency Fos of the resonance circuit 2 in the case of a pot floatation or separation may vary depending on a control speed of frequency control in a normal operation and a threshold used to detect a pot flotation/separation. Although not particularly limited, the amount of a shift of the resonance frequency Fos based on the inverter current exceeding 30 A at a control speed in the current state may be about 0.5 to about 2.5 [kHz].

Upon determining in operation S2 that no floatation or separation of the pot has occurred (NO in operation S2), the process in FIG. 2 ends and the controller 6 continues the normal operation. Although not shown, the determination of operation S2 may be performed every predetermined period during the normal driving operation. On the other hand, upon determining in operation S2 that a pot floatation or separation has occurred (YES in operation S2), the flow proceeds to the next operation S3.

In operation S3, the driving frequency of the inverter 1 at a current point in time is compared with a predetermined frequency setting value Fc. The frequency setting value Fc is a value determined based on a relationship between a control speed of the controller 6 and an impedance deviation caused by a pot separation. The frequency setting value Fc is set within a range of shift amount of the resonance frequency Fos of the resonance circuit 2, for example, set to 1 kHz. Here, the predetermined frequency setting value Fc may be arbitrarily set, but is not limited to the above-described value or method of setting the value.

In response to the driving frequency at the current point in time (hereinafter, referred to as a current frequency) of the inverter 1 being greater than the frequency setting value Fc in operation S3 (YES in operation S3), the flow proceeds to operation S4. In operation S4, the controller 6 lowers the driving frequency of the inverter 1 by a preset frequency Fd (e.g., 1 [kHz]), and the flow proceeds to the next operation S5. Further, in response to the current frequency of the inverter 1 being equal to or less than the frequency setting value Fc in operation S3 (NO in operation S3), the flow directly proceeds to operation S5.

In operation S5, the output of the inverter 1 at the current point in time (hereinafter, referred to as a current output) is compared with a predetermined output setting value Pc. The output setting value Pc is a target value of the output to be finally reached when a pot is separated or floated, and may be arbitrarily set. For example, the output setting value Pc is set to 3% of the maximum output.

In response to the current output of the inverter 1 being greater than the output setting value Pc in operation S5 (YES in operation S5), the flow proceeds to operation S6. In operation S6, the controller 6 lowers the output of the inverter 1 by a preset output Pd (e.g., 3% of the maximum output), and the flow proceeds to operation S7. Further, in response to the current output of the inverter 1 being equal to or less than the output setting value Pc in operation S5 (NO in operation S5), the flow directly proceeds to operation S7.

In operation S7, it is identified whether the process of operations S3 to S6, that is, the process of lowering the driving frequency and output of the inverter 1 has been completed. In response to either of the driving frequency lowering process or the output lowering process not being finished in operation S7, (No in operation S7), the flow returns to operation S3. Accordingly, the processes from operation S3 to operation S6 is repeated until the current frequency and the current output of the inverter 1 become the set values.

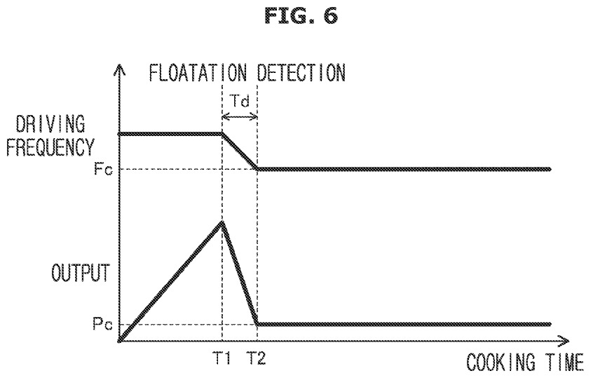

FIG. 6 is a diagram illustrating an example of a change in driving frequency and output in response to detection of a pot floatation, which shows a timing chart of operations from S3 to S6 according to an embodiment of the disclosure.

Referring to FIG. 6, after the pot separation or floatation is detected at a time T1, the process from operation S3 to operation S6 is repeatedly executed until a period Td ends at a time T2. As shown in FIG. 6, between the time T1 and the time T2, the driving frequency of the inverter 1 is gradually lowered to the frequency setting value Fc at the same time as and the output of the inverter 1 is gradually lowered to the output set value Pc. The period Td is not particularly limited, but may be set to about 1 [ms].

Referring to FIG. 6, when the lowering of the driving frequency (operation S4) ends almost simultaneously as the lowering of the output (operation S6), or when the lowering of the driving frequency ends earlier than the lowering of the output, operation S7 shown in FIG. 2 may be omitted. In addition, when the lowering of the driving frequency ends earlier than the lowering of the output, the process of operation S3 and the process of operation S5 may be performed in a reversed order.

According to the embodiment described above, when a pot separation or a pot floatation is detected, the output of the inverter 1 and the driving frequency of the inverter 1 are lowered to reduce the heating capacity of the induction heating device A. Accordingly, the heating capacity of the induction heating device A is reduced while maintaining the impedance of the resonance circuit 2, thereby preventing overcurrent from occurring due to a current flowing through the heating coil 3 being increased.

In particular, when the driving frequency of the inverter 1 deviates from the parallel resonance frequency (for example, a deviation from the rectangular region Q in FIG. 4), and thus the current I3 significantly increases, the configuration of FIG. 1 according to the disclosure remarkable technical improvement than with the prior art.

Here, the lowering of the output of the inverter 1 together with the driving frequency of the inverter 1 includes lowering the output of the inverter 1 at the same time as lowering the driving frequency of the inverter 1, and lowering the output of the inverter 1 together with the driving frequency of the inverter 1 with the start and ending timing and the time interval slightly mismatched between the lowering of the output of the inverter 1 and the lowering of the driving frequency of the inverter 1.

### Other Embodiments

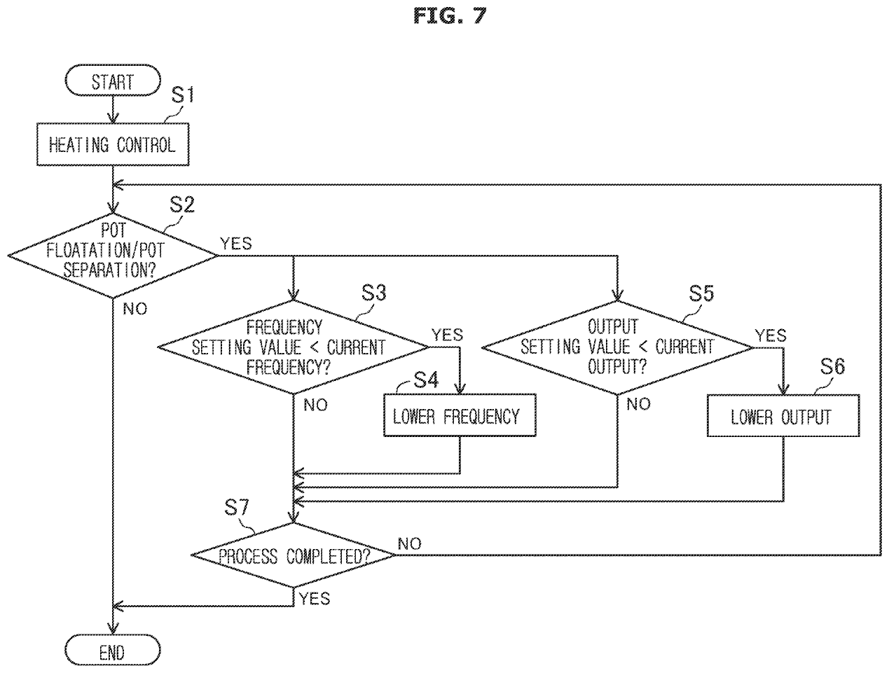

FIG. 7 is a flowchart illustrating another example of the method of controlling the induction heating device according an embodiment of the disclosure.

In the above embodiment, the controller 6 may perform control according to the flowchart shown in FIG. 7 instead of the flowchart of FIG. 2.

Referring to FIG. 7, the comparison process of operation S3 and the comparison process of operation S5 are performed simultaneously.

In the flowchart of FIG. 7, each process from operation S1 to operation S6 is the same as the above. The process from operation S3 to S6 is followed by operation S7 of determining whether the processes of lowering the driving frequency and the output of the inverter 1 have ended.

Referring to FIG. 7, the process from operation S2 to operation S6 is repeated until both the gradual lowering of the driving frequency of the inverter 1 and the gradual lowering of the output of the inverter 1 are completed. The processes shown in FIG. 7 also provide the same effect as those shown in the above embodiment (the processes in FIG. 2).

In the above embodiment, an example of providing two ammeters has been described, but the disclosure is not limited thereto. Although not shown, when the controller 6 identifies the power output from the inverter 1, one of the ammeters 45 and 46 may be omitted. In this case, the displacement of the object may be detected based on the change in the output of the inverter 1 and the value of the grounded ammeter.

The configuration of the resonance circuit 2 in the above embodiment is not limited to the configuration shown in FIG. 1. For example, in FIG. 1, the resonance circuit 2 may be configured such that the first heating coil 31 and the second heating coil 32 have a winding start position at a side of the node N1, and the current flows in the same direction (left to right in FIG. 1). However, with the configuration shown in FIG. 1, the current I3 flowing through the nodes N1 and N2 during normal operation may be reduced as described above.

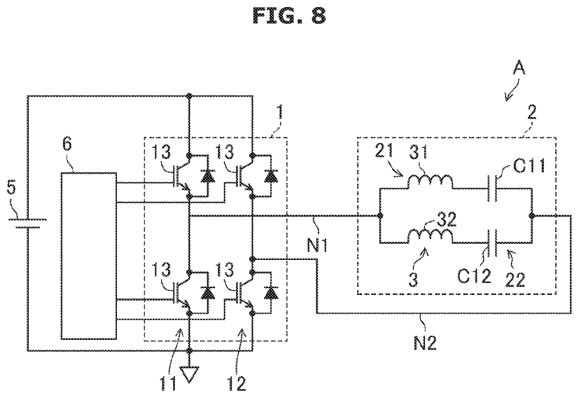

Further, instead of the resonance circuit 2 of FIG. 1, configurations shown as in FIGS. 8 to 12 may be used. In FIGS. 8 to 12, components except for the resonance circuit and operations of the controller 6 are the same as those described in the above embodiment, and even the replacement of the resonance circuit 2 provides the same effects as those of the above embodiment.

FIGS. 8 to 12 are diagrams illustrating other examples of the configuration of the induction heating device according to various embodiments of the disclosure.

FIG. 8, compared to FIG. 1, additionally includes a condenser C12 connected in series to the second heating coil 32. Specifically, a resonance circuit 2 of FIG. 8 includes a first series circuit having a first heating coil 31 and a condenser C11 connected in series and a second series circuit having a second heating coil 32 and a condenser C12 connected in series between a first node N1 and a second node N2. Accordingly, the first series circuit and the second series circuit are connected in parallel.

The resonance circuit 2 of FIG. 8 is also a compound resonance circuit including a series resonance circuit 21 and a parallel resonance circuit 22 similarly to the resonance circuit 2 of FIG. 1.

Referring to FIG. 8, the series resonance circuit 21 includes the first heating coil 31 and the condenser C11, and the parallel resonance circuit 22 includes the first and second heating coils 31 and 32 and the condensers C11 and C12.

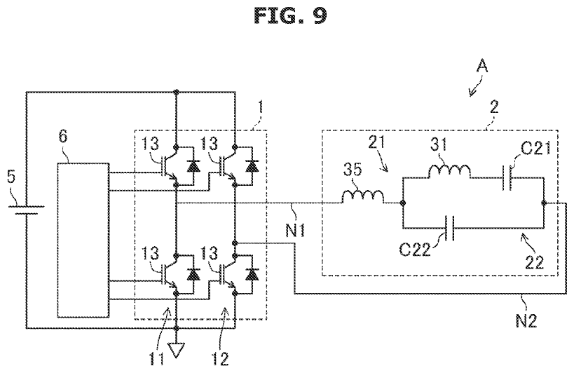

In a resonance circuit 2 shown in FIG. 9, a normal coil 35, a first heating coil 31, and a condenser C21 are connected in series between a first node N1 and a second node N2. In addition, a condenser C22 is connected in parallel to a series circuit including the first heating coil 31 and the condenser C21.

The resonance circuit 2 of FIG. 9, similar to FIG. 1, is a compound resonance circuit including a series resonance circuit 21 and a parallel resonance circuit 22.

Referring to FIG. 9, the series resonance circuit 21 includes the normal coil 35, the first heating coil 31, and the capacitor C21, and the parallel resonance circuit 22 includes the first heating coil 31 and the normal coil and the condensers C21 and C22. In the embodiment described in FIG. 9, a coil that is not for heating will be referred to as a “normal coil” for the sake of convenience in distinguishing from a heating coil. In other words, the term “normal” for the normal coil is not intended to impose any limitation on the coil. That is, the shape and configuration of the coil are not particularly limited, and various coils of the related art may be employed.

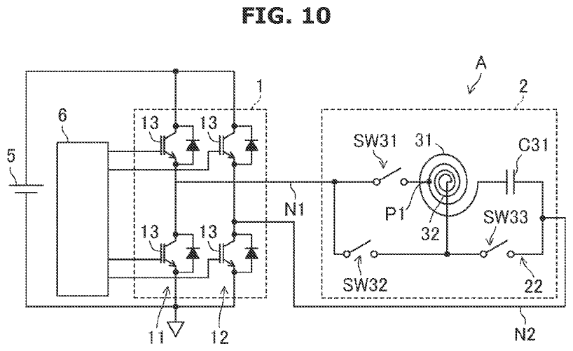

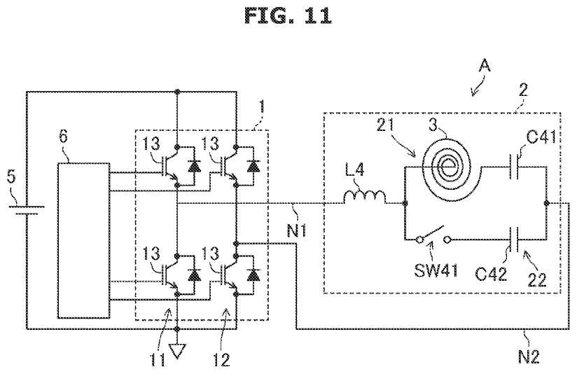

A resonance circuit 2 shown in FIGS. 10 and 11 is configured to enable switching between a series resonance circuit and a compound resonance circuit. In an induction heating apparatus A shown in FIGS. 10 and 11, it may be identified whether to use only a series resonance circuit or use a compound resonance circuit according to the material of the object. The controller 6 may control switch according to the material of the object, to operate the resonance circuit 2 as a series resonance circuit or a compound resonance circuit.

Referring to FIG. 10, a heating coil 3 is spirally wound in a predetermined direction, and an intermediate point P1 located in the middle of the heating coil 3 is connected to a first node N1 through a switch SW31. That is, the heating coil 3 is divided into a first heating coil 31 and a second heating coil 32 with the intermediate point P1 as a boundary. In other words, one end of the first heating coil 31 and one end of the second heating coil 32 are connected to the intermediate point P1.

The first heating coil 31 and the second heating coil 32 have different winding directions with respect to the first node N1. The other end of the second heating coil 32 is connected to the first node N1 through a switch SW32 and to the second node N2 through a switch SW33. The other end of the first heating coil 31 is connected to the second node N2 through a condenser C31.

Referring to FIG. 11, in a resonance circuit 2, an inductor L4, a heating coil 3, and a condenser C41 are connected in series between a first node N1 and a second node N2. In addition, a series circuit including a switch SW41 and a condenser C42 is connected in parallel with a series circuit including the heating coil 3 and the condenser C41.

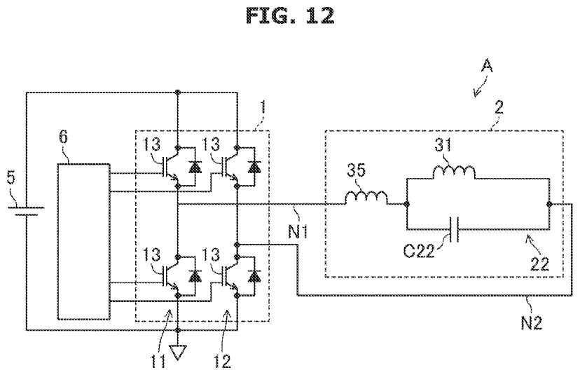

A resonance circuit 2 shown in FIG. 12 includes only a parallel resonance circuit 22. Referring to FIG. 12, a normal coil 35 and a parallel resonance circuit 22 are connected in series between a first node N1 and a second node N2. Further, the parallel resonance circuit 22 includes a first heating coil 31 and a condenser C.

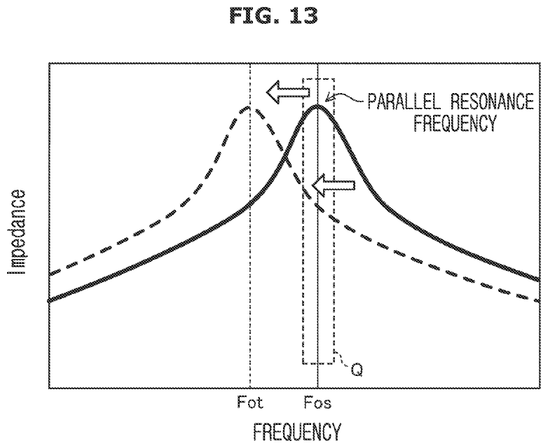

FIG. 13 is a diagram illustrating a frequency characteristic of the impedance in the induction heating apparatus shown in FIG. 12 according to an embodiment of the disclosure.

Referring to FIG. 13, a frequency range during normal operation control of the controller 6 is indicated by a dotted rectangular area Q, similar to FIG. 5. The rectangular region Q is an example showing the vicinity of the resonance frequency of the parallel resonance circuit 22 under the control of the controller 6.

In FIG. 13, a solid line indicates a frequency-impedance characteristic in a normal operation state, and a dotted line indicates a frequency-impedance characteristic in a pot floatation/pot separation, similar to FIG. 5. Here, a detailed control operation of the controller 6 is the same as that in the above embodiment, and thus detailed descriptions thereof are omitted. The same effect as in the above embodiment may be obtained even when the resonance circuit 2 is composed of only the parallel resonance circuit 22 as shown in FIG. 12.

As is apparent from the above, the induction heating device and the method of controlling the same can prevent occurrence of overcurrent even when an object is moved in the induction heating device using a resonance circuit method.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An induction heating device for heating an object, the induction heating device comprising:
a resonance circuit including a heating coil and a condenser;
an inverter configured to supply power to the resonance circuit;
a detector configured to detect a value related to a movement of the object; and
at least one processor configured to:
identify whether the object is moved based on the value detected by the detector, and
upon determining that the object is moved, lower a driving frequency of the inverter and an output of the inverter.

2. The induction heating device of claim 1, wherein the at least one processor is further configured to:
lower the driving frequency of the inverter and the output of the inverter to maintain an impedance of the resonance circuit while lowering a heating capacity of the induction heating device.

3. The induction heating device of claim 1, wherein upon determining that the object is moved, the at least one processor is further configured to:
compare the driving frequency of the inverter with a frequency setting value, and
in response to the driving frequency of the inverter being larger than the frequency setting value, lower the driving frequency of the inverter by a preset frequency.

4. The induction heating device of claim 3, wherein the at least one processor is further configured to lower the driving frequency of the inverter by the preset frequency until the driving frequency of the inverter becomes lower than or equal to the frequency setting value.

5. The induction heating device of claim 1, wherein upon determining that object is moved, the least one processor is further configured to:
compare the output of the inverter with an output setting value, and
in response to the output of the inverter being larger than the output setting value, lower the output of the inverter by a preset output.

6. The induction heating device of claim 5, wherein the at least one processor is further configured to lower the output of the inverter by the preset output until the output of the inverter becomes lower than or equal to the output setting value.

7. The induction heating device of claim 1,
wherein the resonance circuit includes a compound resonance circuit including a series resonance circuit and a parallel resonance circuit, and
wherein the at least one processor is further configured to control the driving frequency of the inverter for the parallel resonance circuit to operate near a resonance frequency.

8. The induction heating device of claim 7,
wherein the resonance circuit is switchable between a series resonance circuit and a complex resonance circuit by on and off operations of a switch, and
wherein the at least one processor is further configured to control the switch for the resonance circuit to operate as the series resonance circuit or as the compound resonance circuit.

9. The induction heating device of claim 1,
wherein the detector includes at least one ammeter configured to detect a current flowing through the heating coil, and
wherein the at least one processor is further configured to identify that the object is moved in response to a value of the current detected by the ammeter exceeding a reference current value.

10. The induction heating device of claim 1,
wherein the detector includes an ammeter configured to detect a current flowing through the heating coil, and
wherein the at least one processor is further configured to identify whether the object is moved based on the output of the inverter and a value of the current detected by the ammeter.

11. A method of controlling an induction heating device including a resonance circuit including a heating coil and a condenser for heating an object and an inverter for supplying power to the resonance circuit, the method comprising:
detecting, by a detector, a value related to a movement of the object;
determining whether the object is moved based on the value detected by the detector; and
upon determining that the object is moved, lowering a driving frequency of the inverter and an output of the inverter.

12. The method of claim 11, wherein the lowering of the driving frequency of the inverter and the output of the inverter includes lowering the driving frequency of the inverter and the output of the inverter to maintain an impedance of the resonance circuit while lowering a heating capacity of the induction heating device.

13. The method of claim 11, wherein the lowering of the driving frequency of the inverter and the output of the inverter includes:
upon determining that the object is moved, comparing the driving frequency of the inverter with a frequency setting value; and
in response to the driving frequency of the inverter being larger than the frequency setting value, lowering the driving frequency of the inverter by a preset frequency.

14. The method of claim 13, wherein the lowering of the driving frequency of the inverter and the output of the inverter includes lowering the driving frequency of the inverter by the preset frequency until the driving frequency of the inverter becomes lower than or equal to the frequency setting value.

15. The method of claim 11, wherein the lowering of the driving frequency of the inverter and the output of the inverter includes:
upon determining that object is moved, comparing the output of the inverter with an output setting value; and
in response to the output of the inverter being larger than the output setting value, lowering the output of the inverter by a preset output.

16. The method of claim 15, wherein the lowering of the driving frequency of the inverter and the output of the inverter includes lowering the output of the inverter by the preset output until the output of the inverter becomes lower than or equal to the output setting value.

17. The method of claim 11,
wherein the resonance circuit includes a compound resonance circuit including a series resonance circuit and a parallel resonance circuit, and
wherein the method further comprises controlling the driving frequency of the inverter for the parallel resonance circuit to operate near a resonance frequency.

18. The method of claim 17,
wherein the resonance circuit is switchable between a series resonance circuit and a complex resonance circuit by on and off operations of a switch, and
wherein the method further comprises controlling the switch for the resonance circuit to operate as the series resonance circuit or as the compound resonance circuit.

19. The method of claim 11,
wherein the detector further includes at least one ammeter configured to detect a current flowing through the heating coil, and
wherein the determining of whether the object is moved includes determining that the object is moved in response to a value of the current detected by the ammeter exceeding a reference current value.

20. The method of claim 11,
wherein the detector further includes an ammeter configured to detect a current flowing through the heating coil, and
wherein the determining of whether the object is moved includes determining whether the object is moved based on the output of the inverter and a value of the current detected by the ammeter.
